(19) United States
(12) Patent Application Publication
(10) Pub. No.: US 2007/0165851 A1
(43) Pub. Date: Jul. 19, 2007

(54) Watermark detection

(75) Inventor: David K. Roberts, Crawley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/597,819

(22) PCT Filed: Feb. 8, 2005
(86) PCT No.: PCT/IB05/50494

§ 371 Date: Aug. 9, 2006

(30) Foreign Application Priority Data
Feb. 14, 2004 (GB) 0403329.6

(51) Int. Cl. H04N 7/167

(52) U.S. Cl. 380/201

(57) ABSTRACT

An information signal includes a plurality of watermarks (Wi) which together define a payload of data, such as a rights information. A detector (100) detects the presence (60-62) of each of the plurality of watermarks in the information signal and provides an output (101-103) which can be used to determine (70, 75) the payload represented by the watermarks. A measure of confidence in the accuracy of the payload represented by the watermarks is calculated (110) using information (104-106) from the detection stages (60-62). This provides a measure of the quality of the payload to any equipment which relies on the payload results, such as a Digital Rights Management (DRM) system. Information about the shape of correlation peaks obtained in the detection stages (60-62) can be used to derive the measure of confidence in the accuracy of the payload.

This invention relates to detecting a watermark in an information signal.

Watermarking is a technique in which a label of some kind is added to an information signal. The information signal to which the watermark is added can represent a data file, a still image, video, audio or any other kind of media content. The label is embedded in the information signal before the information signal is distributed. The label is usually added in a manner which is imperceptible under normal conditions, in order that it does not degrade the information signal, e.g. a watermark added to an audio file should not be audible under normal listening conditions. However, the watermark should be robust enough to remain detectable even after the information signal has undergone the normal processes during transmission, such as coding or compression, modulation and so on.

A simple watermarking scheme may embed a single watermark in an item of content, with a detection scheme testing for the presence of the single watermark. In this case, the watermark conveys just 1 bit of information: its presence, or its absence. In a development of watermarking technology, it is known to embed multiple watermarks into an information signal, with the combination of watermarks being used to represent a code, known as a payload. The payload can represent, for example, a code such as “copy”, “do not copy” or an identity number of the content. A scheme of this kind is described in the paper “A Video Watermarking System for Broadcast Monitoring”, Ton Kalker et al., Proceedings of the SPIE, Bellingham, Va. vol. 3657, 25 Jan. 1999, p. 103-112. In this scheme the payload is encoded by embedding multiple (e.g. four) basic watermark patterns with spatial shifts relative to each other. The signal under test is individually correlated with each of the basic watermark patterns to produce a buffer of correlation results. The presence of each watermark is indicated by a peak in the correlation results. A watermark is declared present if all four basic watermark patterns produce a correlation peak of height greater than a threshold value of 5σ (five times the standard deviation of the set of correlation results in the results buffer.) This threshold value is chosen to achieve an acceptably low probability of unwatermarked content being mistakenly declared watermarked (a ‘false positive’). If a watermark is found then the payload is decoded by examining the shifts between the basic patterns. Typically it is assumed that if the watermark can be detected reliably, then the payload can also be extracted reliably. However, in practice it is possible for the presence of a watermark to be detected while the extracted payload is in error.

In most applications the watermarked content will undergo various processing operations between the point at which a watermark is embedded in the content and the point at which the presence of the watermark is detected. A common example of content processing is lossy compression, such as MPEG coding. Typically, the effects of processing are to lower the correlation peaks that would normally be expected to occur during the watermark detection process. Thus, the performance of a watermark detection technique based on finding correlation peaks is considerably reduced when attempting to detect watermarks in content which has undergone such processes.

The present invention seeks to provide an improved way of extracting the payload carried by a watermark in an information signal.

Accordingly, a first aspect of the present invention provides a method of processing an information signal in which a plurality of watermarks are present, the plurality of watermarks together defining a payload, the method comprising:

detecting the presence of each of the plurality of watermarks in the information signal;

determining the payload represented by the watermarks; and,

calculating a measure of confidence in the accuracy of the payload represented by the watermarks.

This has the advantage of providing a measure of the quality of the payload to any equipment which relies on the payload results (such as a Digital Rights Management (DRM) system). This can avoid, for example, incorrect rights being assumed in content-management/copy-protection applications. Moreover, it can enable new actions to be taken; a unique response can be defined for cases where a watermark is found (perhaps indicating protected audio/video content) but no payload can be extracted (so the exact rights cannot be determined).

In a preferred embodiment, the information signal is correlated with each expected watermark pattern to derive sets of correlation results. Information about the shape of the correlation peak can be used to derive the measure of confidence in the accuracy of the payload.

The functionality described here can be implemented in software, hardware or a combination of these. Accordingly, another aspect of the invention provides software for performing the method. It will be appreciated that software may be installed on the host apparatus at any point during the life of the equipment. The software may be stored on an electronic memory device, hard disk, optical disk or other machine-readable storage medium. The software may be delivered as a computer program product on a machine-readable carrier or it may be downloaded directly to the apparatus via a network connection.

Further aspects of the invention provide an arrangement for processing an information signal which performs any of the steps of the method and an apparatus for presenting an information signal which responds to the output of the arrangement.

While the described embodiment makes reference to processing an image or video signal (including digital cinema content), it will be appreciated that the information signal can be data representing audio or any other kind of media content.

Embodiments of the present invention will now be described, by way of example only, with reference to the accompanying drawings, in which:

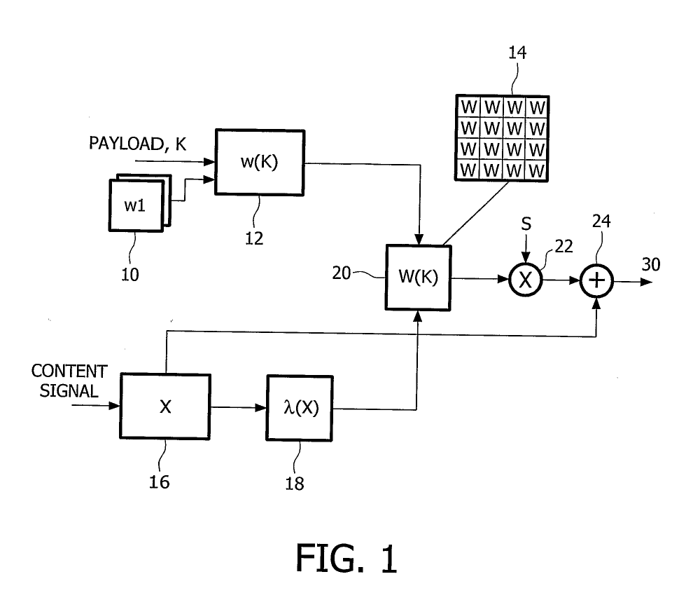

FIG. 1 shows a known way of embedding a watermark in an item of content;

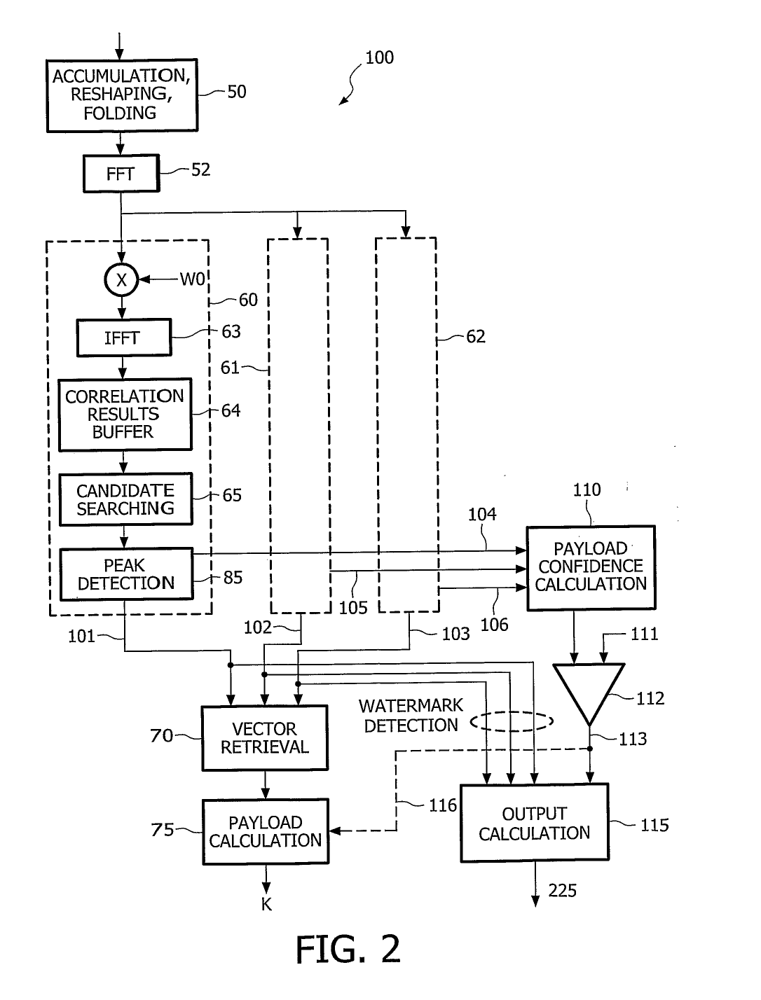

FIG. 2 shows an arrangement for detecting the presence of a watermark in an item of content;

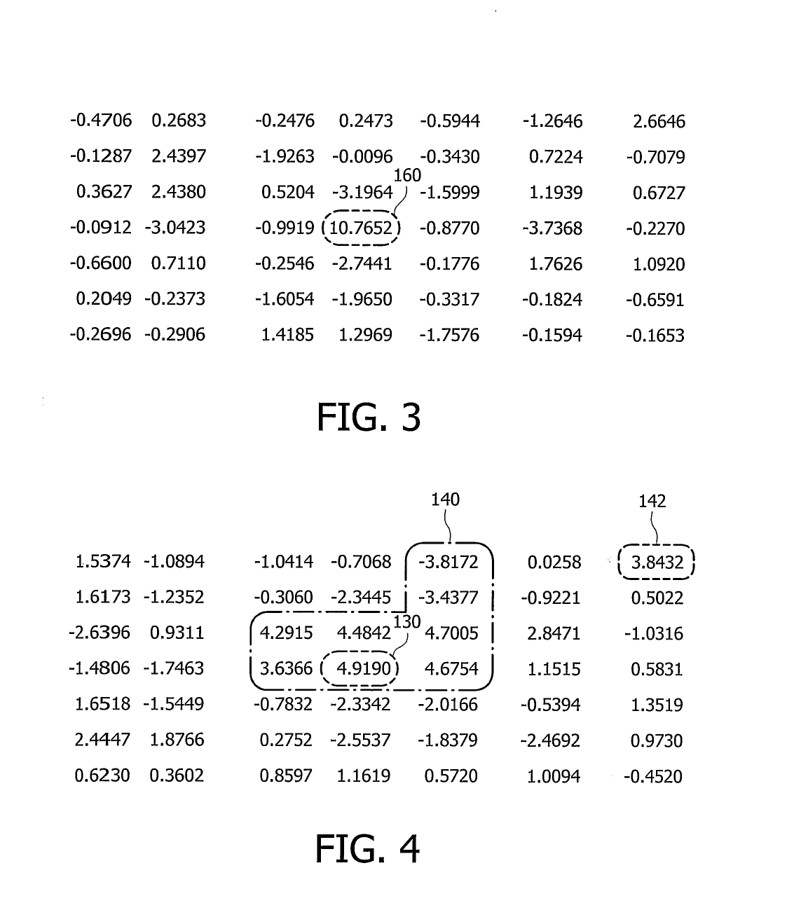

FIGS. 3 and 4 show tables of correlation results for use in the detector and method;

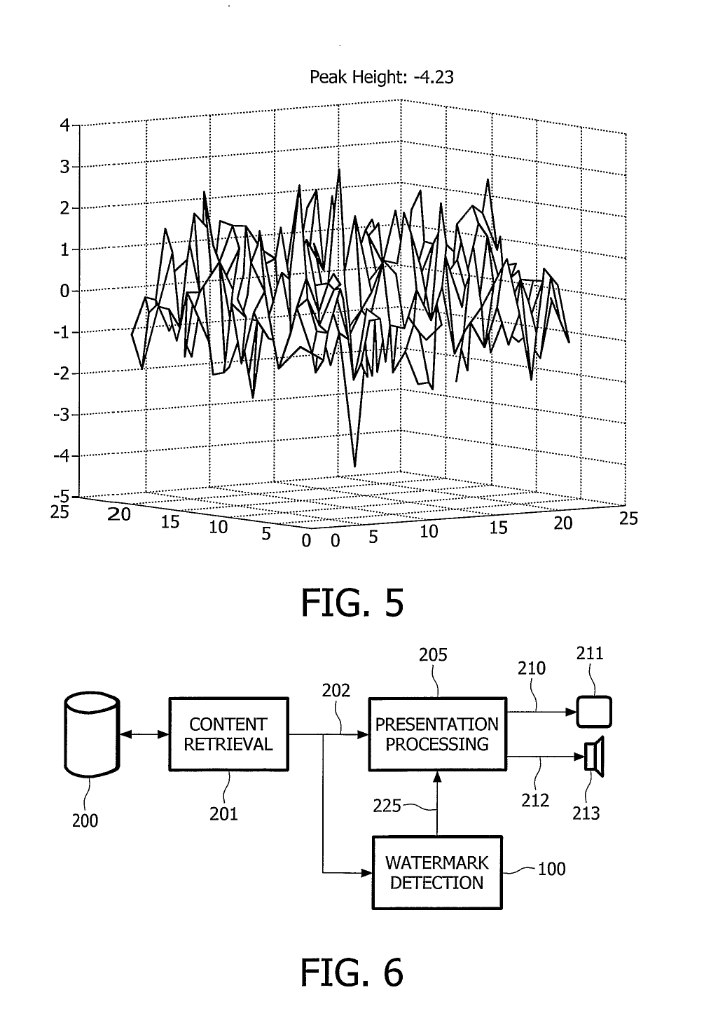

FIG. 5 shows an example set of correlation results data in graphical form;

FIG. 6 shows apparatus for presenting content which embodies the watermark detector.

By way of background, and to understand the invention, a process of embedding a watermark will be briefly described, with reference to FIG. 1. A watermark pattern w(K) is constructed using one or more basic watermark patterns w. Where a payload of data is to be carried by the watermark, a number of basic watermark patterns are used. The watermark pattern w(K) is chosen according to the payload—a multi-bit code K—that is to be embedded. The code is represented by selecting a number of the basic patterns w and offsetting them from each other by a particular distance and direction. The combined watermark pattern w(K) represents a noise pattern which can be added to the content. The watermark pattern w(K) has a size of M×M bits and is typically much smaller than the item of content. Consequently, the M×M pattern is repeated (tiled) 14 into a larger pattern which matches the format of the content data. In the case of an image, the pattern w(K) is tiled 14 such that it equals the size of the image with which it will be combined.

A content signal is received and buffered 16. A measure of local activity λ(X) in the content signal is derived 18 at each pixel position. This provides a measure for the visibility of additive noise and is used to scale the watermark pattern W(K). This prevents the watermark from being perceptible in the content, such as areas of equal brightness in an image. An overall scaling factor s is applied to the watermark at multiplier 22 and this determines the overall strength of the watermark. The choice of s is a compromise between the degree of robustness that is required and the requirement for how perceptible the watermark should be. Finally, the watermark signal W(K) is added 24 to the content signal. The resulting signal, with the watermark embedded within it, will then be subject to various processing steps as part of the normal distribution of that content.

FIG. 2 shows a schematic diagram of a watermark detector 100. The watermark detector receives content that may be watermarked. In the following description the content is assumed to be images or video content. Watermark detection may be performed for individual frames or for groups of frames. Accumulated frames are partitioned into blocks of size M×M (e.g. M=128) and then folded into a buffer of size M×M. These initial steps are shown as block 50. The data in the buffer is then subject to a Fast Fourier Transform 52. The next step in the detection process determines the presence of watermarks in the data held in the buffer 64. To detect whether or not the buffer includes a particular watermark pattern W, the buffer contents and the expected watermark pattern are subjected to correlation. As the content data may include multiple watermark patterns, a number of parallel branches 60, 61, 62 are shown, each one performing correlation with one of the basic watermark patterns W0, W1, W2. One of the branches is shown in more detail. The correlation values for all possible shift vectors of a basic pattern Wi are simultaneously computed. The basic watermark pattern Wi (i=0,1,2) is subjected to a Fast Fourier Transform (FFT) before correlation with the data signal. The set of correlation values is then subject to an inverse Fast Fourier transform 63. Full details of the correlation operation are described in U.S. Pat. No. 6,505,223 B1.

The Fourier coefficients used in the correlation are complex numbers, with a real part and an imaginary part, representing a magnitude and a phase. It has been found that the reliability of the detector is significantly improved if the magnitude information is thrown away and the phase is considered only. A magnitude normalization operation can be performed after the pointwise multiplication and before the inverse Fourier Transform 63. The operation of the normalization circuit comprises pointwise dividing each coefficient by its magnitude. This overall detection technique is known as Symmetrical Phase Only Matched Filtering (SPOMF).

The set of correlation results from the above processing are stored in a buffer 64. A small example set of correlation results are shown in FIG. 3. Watermarked content is indicated by the presence of peaks in the correlation results data. The set of correlation results are examined to identify peaks that might be due to the presence of a watermark in the content data. Under ideal conditions the presence of a watermark will be indicated by a sharp, isolated peak of significant height, but it is more likely that previous processing operations during distribution of the content will cause a correlation peak to be smeared over several adjacent positions in the correlation results. An initial processing stage 65 identifies candidate clusters of correlation results data which may represent correlation peaks. A technique for identifying candidate peaks is described in more detail later.

Once candidate peaks have been identified, a further processing stage 85 decides which is most likely to be due to a watermark. Once a valid peak has been identified in one or more sets of correlation data, a vector retrieval stage 70 matches the different sets of data to find a vector between the watermark patterns, i.e. to identify the distance and direction by which the different patterns w0, w1, w2 are offset from one another. In a final step 75, the vectors identified in the preceding step 70 are converted into a code K, representing the payload of the watermark.

The peak detection stage 85 of each branch 60, 61, 62 outputs a respective signal 101, 102, 103 representing whether a watermark pattern has been found in that branch. In addition, information 104, 105, 106 from each branch 60, 61, 62 is applied to a payload confidence calculation unit 110. Confidence calculation unit 110 performs a calculation to determine a measure of how reliable the extracted payload K is.

The measure of confidence is applied to a comparator 112, which compares the measure of confidence with a threshold value 111 representing an acceptable level of confidence. Threshold value 111 can be set to any desired value, depending on the application. A final stage 115 receives the watermark detection signals and provides an output 225 which is dependent on the watermark detection signals 101, 102, 103 and the confidence value 113. There are three possible outcomes:

(a) no watermark is found (one or more of the watermark detection signals 101,102, 103 indicates that no watermark is present);

(b) a watermark is found and the payload is extracted (all watermark detection signals 101, 102, 103 indicate that a watermark was found and the confidence value 113 is high);

(c) a watermark is found, but the payload cannot be reliably determined (all watermark detection signals 101, 102, 103 indicate that a watermark was found and the confidence value 113 is low).

Output 225 can be used by a digital rights management system to provide an appropriate action. For example, where the payload indicates copy restrictions (e.g. ‘do not copy’; ‘copy once’; ‘copy freely’) and output 225 indicates condition (c) above, the digital rights management system can allow the content to be presented but will not allow the content to be copied.

There are various ways in which detector 100 can operate. In a most simple form, the correlation results in buffer 64 are compared with a threshold value to identify a significant peak. Typically, the threshold is set at a value of 5σ (five times the standard deviation of the set of correlation results in the results buffer.)

In a more elaborate scheme, correlation peaks which are ‘smeared’ can detected by setting a lower threshold and identifying clusters of correlation results of significant value. Where there are multiple peaks, these are assessed to identify the peak that is most likely to represent the true peak. A technique for achieving this is described later.

In a further elaboration, the shape of the correlation peak can be compared with stored information about an expected shape, such as by cross-correlation. A good match in the shape can indicate the presence of a correlation peak, even if it has been significantly smeared. Different processes that a content signal undergoes during distribution can each have a characteristic, and thereby recognizable, effect on the shape of the correlation peak. The shape of the peak can be better understood by viewing the correlation results in the form of a graph, with the correlation value being plotted as height above a base line of the graph, as shown in FIG. 5. Information about the shape of the peak is supplied 104, 105, 106 to the confidence calculation unit 110.

From this, it will be understood that it is possible to detect the presence of watermarks even where the correlation results are less than ideal. However, the smearing of a correlation peak introduces some uncertainty in the calculation of the payload. Taking the example of a scheme where the relative position of correlation peaks determines the payload, a smeared or flattened peak introduces ambiguity in the true position of a peak. Payload confidence calculation unit 110 bases the confidence value on peak shape information obtained from unit 85.

Referring again to FIGS. 3 and 4, these show two sets of correlation results data of the kind that would be stored in buffer 64. FIG. 3 shows the kind of data that would be collected where a sharp, well-defined correlation peak 160 occurs. Table 1 shows probability of error values for the results data of FIG. 3. The payload error probabilities are given by Equation 8 (see Appendix) for various assumed peak sizes all centered on the highest point in the buffer. The values of C represent the number of results values that are included in the correlation peak cluster. Three differently-sized clusters are considered: C=1 is just a single point; C=9 is a 3×3 square centred on the correlation peak, and C=25 is a 5×5 square centred on the correlation peak. For simplicity, it is assumed that all possible payload shifts are equally likely.

TABLE 1
Pr(error) for FIG. 3

| 1 × 1 (C = 1) | 3 × 3 (C = 9) | 5 × 5 (C = 25) |
|---|---|---|
| 5.803 × 10⁻¹⁰ | 1.732 × 10⁻¹⁴ | 2.624 × 10⁻¹¹ |

In contrast, FIG. 4 shows correlation results data for a lower, widely smeared (flattened) correlation peak and Table 2 shows probability of error values for this data.

TABLE 2
Pr(error) for FIG. 4

| 1 × 1 (C = 1) | 3 × 3 (C = 9) | 5 × 5 (C = 25) |
|---|---|---|
| 1.0 | 8.719 × 10⁻³ | 2.775 × 10⁻³ |

It is clear that the peak shape in the buffer of FIG. 3 leads to a far higher confidence in the correctness of the extracted payload (Table 1) compared to the flattened peak of FIG. 4 (Table 2). In these examples the cluster of correlation results that are taken to form the peak are a square grid of results centred on the correlation result having the highest value. For example, looking at FIG. 4, this would be the square of results around the result 130 with the value 4.9190. Where a more efficient technique is used to identify clusters (as described below), the cluster identified by that detection technique can be used. The clusters of results do not need to be square, as in the examples above.

Referring back to FIG. 2, the output 113 from the comparator 112 can be applied to the payload calculation unit 75, as shown by line 116. If the confidence value of the payload is less than the threshold confidence value 111, then the payload calculation unit 75 can be instructed to not calculate the payload K. Thus, in situations where the payload is likely to be incorrect, it is not output at all.

A process for identifying candidate correlation peaks in the correlation results, for use in unit 65 of FIG. 2, will now be described. The clustering algorithm forms a number of clusters of points, any of which may correspond to the true correlation peak. The likelihoods of these clusters are compared, and the cluster with the lowest likelihood is assumed to be the wanted correlation peak. The algorithm comprises the following steps:

1. Set a threshold value and find all points in the correlation data which are above this threshold value. All points meeting this criteria are stored in a list—ptsAboveThresh. A suggested threshold value is 3.3σ (σ=standard deviation of results in the buffer) although this can be set to any preferred value. A preferred range is 2.5-4σ. If the threshold value is set too low a large number of points, which do not correspond to the presence of a watermark, will be stored in the list. Conversely, if the value is set too high there is a risk that points corresponding to a valid, but smeared, peak will not be added to the list.

2. Find the point with the highest absolute value.

3. Form candidate clusters, i.e. clusters of correlation points. Candidate clusters are formed by collecting points that not only have ‘significant’ value (a value greater than the threshold), but which are also located very close to at least one other point of significant value. This is achieved as follows:
(i) Remove the first point from the ptsAboveThresh list and enter it as the first point p of a new cluster;
(ii) Search ptsAboveThresh for points that are within a distance d of point p. Remove all such points from the ptsAboveThresh list, and add them to the cluster;
(iii) Take the next point in the cluster as the current point p. Repeat step (ii) in order to add to the cluster all points in ptsAboveThresh that are within distance d of the new point p.
(iv) Repeat Step (iii) until ptsAboveThresh has been processed for all points in the cluster;
(v) If the resulting cluster consists of only a single point and that point is not equal to the highest peak found in Step 2 above, then discard this cluster;
(vi) Repeat Steps (i) to (v) until ptsAboveThresh is empty.
   At the end of this procedure, all points originally entered into ptsAboveThresh in Step 1 above have been either:

assigned to a cluster containing other points from the ptsAboveThresh list that are close to it, or

discarded, as they have no neighbours of similar height, and are therefore not part of a cluster.

A cluster is only allowed to comprise a single point if that point has the largest absolute height of all the points in the correlation buffer. This prevents a sharp, unsmeared, correlation peak from being discarded, but prevents other isolated peaks, representing true noise, from being used.

Referring back to FIGS. 3 and 4, these show some example sets of correlation data of the type that that would be calculated by the detector. In the set of data shown in FIG. 4 the values range between −3.8172 and 4.9190. Watermarks may be embedded with negative value, and hence negative values are also significant. The highest value of 4.9190 is shown within box 130. Although this is below the typical detection threshold of 5, the highest value is surrounded by other correlation values of a similar value. This is indicative of a peak which has been smeared by processing during the distribution chain. Following the procedure described above, and setting a threshold T of 3.3 and a distance of 1, it can be found that the correlation values within ring 140 meet this criteria. Working through the process, the results of significant value are all located alongside each other. Looking at the data shown in FIG. 3, the values range between −3.7368 and 10.7652. Applying the same detection criteria, only one point 160 exceeds the threshold. The value of this point clearly exceeds the threshold and thus is considered to be a valid peak. From inspecting the neighbouring values, it can be seen that this represents a sharp correlation peak.

The embedded information represented as payload code K may identify, for example, the copy-right holder or a description of the content. In DVD copy-protection, it allows material to be labelled as ‘copy once’, ‘never copy’, ‘no restriction’, ‘copy no more’, etc. FIG. 10 shows an apparatus for retrieving and presenting a content signal which is stored on a storage medium 200, such as an optical disk, memory device or hard disk. The content signal is retrieved by a content retrieval unit 201. The content signal 202 is applied to a processing unit 205, which decodes the data and renders it for presentation 211, 213. The content signal 202 is also applied to a watermark detection unit 220 of the type previously described. The processing unit 205 is arranged so that it is only permitted to process the content signal if a predetermined watermark is detected in the signal. A control signal 225 sent from the watermark detection unit 220 informs the processing unit 205 whether processing of the content should be allowed or denied, or informs the processing unit 205 of any copying restrictions associated with the content. Alternatively, the processing unit 205 can be arranged so that it is only permitted to process the content signal if a predetermined watermark is not detected in the signal.

In the above description, a set of three watermarks have been considered. However, it will be appreciated that the technique can be applied to find a correlation peak in content data carrying any number of watermarks.

In the above embodiment, a correlation technique is used to detect the presence of a watermark in the content. There are many other known ways of detecting the presence of a watermark, and the present invention can be applied to any of these in a manner which will be well understood by a skilled person.

In the description above, and with reference to the Figures, there is described an information signal which includes a plurality of watermarks Wi which together define a payload of data, such as rights information. A detector 100 detects the presence 60-62 of each of the plurality of watermarks in the information signal and provides an output 101-103 which can be used to determine 70, 75 the payload represented by the watermarks. A measure of confidence in the accuracy of the payload represented by the watermarks is calculated 110 using information 104-106 from the detection stages. This provides a measure of the quality of the payload to any equipment which relies on the payload results, such as a Digital Rights Management (DRM) system. Information about the shape of correlation peaks obtained in the detection stages 60-62 can be used to derive the measure of confidence in the accuracy of the payload.

Appendix

This section derives a confidence measure of the correctness of a payload for a correlation-based detection scheme such as JAWS, developed by Philips.

The Maximum A Posteriori (MAP) estimate \hat{τ} of the shift corresponding to the payload is:

$$\hat{τ} = {max}_{i} Pr [ {τ}_{i} \vert y , s , {H}_{W} ]$$

This says that, given a buffer of SPOMF results y, a correlation peak shape s, and that the content is watermarked (H_{W}), the estimated payload shift is the one with highest probability. The watermark correlation peak can be assumed to comprise of C adjacent points, such that the elements of the peak shape vector S_{τ} are:

$${s}_{τ} ( k ) = {\sum }_{i = 0}^{C - 1} {a}_{i} δ ( k - τ - i ) \qquad ( 1 )$$

and the shape of the peak is controlled by the vector of parameters a=[α₀ α₁ . . . α_{C-1}]^{T}. Supposing that each possible payload shift τᵢ has a prior probability Pr[τᵢ] then:

$$\hat{τ} = {max}_{i} p ( y \vert {τ}_{i} , s , {H}_{W} ) Pr [ {τ}_{i} ] \qquad ( 2 )$$

In some applications it may be possible to assume that all possible payload shifts have equal prior probabilities, and therefore do not influence the choice of \hat{τ}. However, this will not be the case in all applications. For example, in copy protection perhaps only four possible payloads are used corresponding to the messages ‘Don't copy’, ‘Copy freely’, ‘Copy once’, and ‘Copy no more’. Furthermore, these four payloads do not necessarily have equal probability as there may be far more ‘Copy freely’ content than protected content, or vice versa.

In the case of unwatermarked material ( H̅_̅{̅W̅}̅), it has been shown that the N elements of y are approximately independent gaussian white noise. In the case of are watermarked material (H_{W}), experiment shows that the SPOMF results are again approximately gaussian noise, but there also exists a peak. The PDF under H_{W} is therefore:

$$\begin{matrix}p ( y \vert {H}_{W} , s , τ ) = {\prod }_{k = 0}^{N - 1} {( 2 π )}^{- \frac{1}{2}} exp [ - \frac{1}{2} {( y ( k ) - {s}_{τ} ( k ) )}^{2} ] \\ = {( 2 π )}^{- \frac{N}{2}} exp [ - \frac{1}{2} {\sum }_{k = 0}^{N - 1} {( y ( k ) - {s}_{τ} ( k ) )}^{2} ]\end{matrix} \qquad ( 3 )$$

Substituting this into Equation 2 gives:

$$\begin{matrix}\hat{τ} = {max}_{i} Pr [ {τ}_{i} ] {( 2 π )}^{- \frac{N}{2}} exp [ - \frac{1}{2} {\sum }_{k = 0}^{N - 1} {( y ( k ) - {s}_{τ i} ( k ) )}^{2} ] \\ = {max}_{i} Pr [ {τ}_{i} ] {( 2 π )}^{- \frac{N}{2}} exp [ - \frac{1}{2} ( {\sum }_{k = 0}^{N - 1} {y ( k )}^{2} - 2 {\sum }_{k = 0}^{N - 1} y ( k ) {s}_{τ i} ( k ) + {\sum }_{k = 0}^{N - 1} {s}_{τ i}^{2} ( k ) ) ]\end{matrix}$$

This equation can be further simplified by dropping all the terms that are constant with respect to the value of i. This includes the both the first and the third summations in the above expression, due to the shifts being cyclic. The result is:

$$\hat{τ} = {max}_{i} Pr [ {τ}_{i} ] exp [ {\sum }_{k = 0}^{N - 1} y ( k ) {s}_{τ i} ( k ) ] \qquad ( 4 )$$

This shows that the best estimate of the payload shift is dictated by the prior probability of each shift, and the cross-correlation between the SPOMF buffer contents y and the peak shape s. Substituting the peak shape model of Equation 1 into Equation 4 gives,

$$\hat{τ} = {max}_{i} Pr [ {τ}_{i} ] exp [ {\sum }_{l = 0}^{C - 1} {a}_{l} y ( {τ}_{i} + l ) ] \qquad ( 5 )$$

A confidence measure of the extracted payload can be derived from the probability of error in the choice of \hat{τ}. An error is made if at least one shift τᵢ possesses a higher probability Pr[τᵢ|y,s,H_{W}] than that of the shift τ_{C} corresponding to the correct payload:

$$\begin{matrix}Pr [ Error ] = 1 - {\prod }_{{i = 0}_{i \neq c}}^{N - 1} ( Pr [ {τ}_{C} \vert y , s , {H}_{W} ] > Pr [ {τ}_{i} \vert y , s , {H}_{W} ] \\ = 1 - {\prod }_{{i = 0}_{i \neq c}}^{N - 1} {p}_{c , i}\end{matrix} \qquad ( 6 )$$

Using Equation 5, p_{c,i} can be written:

$$\begin{matrix}{p}_{c , i} = Pr [ Pr [ {τ}_{c} ] exp ( {\sum }_{l - 0}^{C - 1} {a}_{l} y ( {τ}_{c} + l ) ) > Pr [ {τ}_{i} ] exp ( {\sum }_{l = 0}^{C - 1} {a}_{l} y ( {τ}_{i} + l ) ) \\ = Pr [ exp ( {\sum }_{l = 0}^{C - 1} {a}_{l} [ y ( {τ}_{c} + l ) - y ( {τ}_{i} + l ) ] ) > \frac{Pr [ {τ}_{i} ]}{Pr [ {τ}_{c} ]} ] \\ = Pr [ {\sum }_{l = 0}^{C - 1} {a}_{l} y ( {τ}_{c} + l ) > {\sum }_{l = 0}^{C - 1} {a}_{l} y ( {τ}_{i} + l ) + ln ( \frac{Pr [ {τ}_{i} ]}{Pr [ {τ}_{c} ]} ) ]\end{matrix} \qquad ( 7 )$$

If τ_{c} is the shift corresponding to the correct payload, then from Equation 1:

$$\begin{matrix}y ( {τ}_{c} + l ) = {s}_{{τ}_{c}} ( l ) + n ( {τ}_{c} + l ) \\ = {\sum }_{m - 0}^{C - 1} {a}_{m} δ ( l - m ) + n ( {τ}_{c} + l ) \\ = {a}_{l} + n ( {τ}_{c} + l )\end{matrix}$$

where n(.) is AWGN. Likewise:

$$\begin{matrix}y ( {τ}_{i} + l ) = {s}_{{τ}_{c}} ( {τ}_{i} + l ) + n ( {τ}_{i} + l ) \\ = {\sum }_{m = 0}^{C - 1} {α}_{m} δ ( l + {τ}_{i} - {τ}_{c} - m ) + n ( {τ}_{i} + l ) \\ = {a}_{l + {τ}_{i} - {τ}_{c}} + n ( {τ}_{i} + l )\end{matrix}$$

Substituting these two expressions into Equation 7 gives:

$$\begin{matrix}{p}_{c , i} = Pr [ {\sum }_{l = 0}^{C - 1} {a}_{l} ( {a}_{l} + n ( {τ}_{c} + l ) ) > {\sum }_{l = 0}^{C - 1} {a}_{l} ( {a}_{l - {τ}_{i} - {τ}_{c}} + n ( {τ}_{i} + l ) ) + ln ( \frac{Pr [ {τ}_{i} ]}{Pr [ {τ}_{c} ]} ) ] \\ = Pr [ {\sum }_{l = 0}^{C - 1} {a}_{l} ( n ( {τ}_{c} + l ) - n ( {τ}_{i} + l ) ) > - {\sum }_{l = 0}^{C - 1} {a}_{l}^{2} + {\sum }_{i = 0}^{C - 1} {a}_{l + {τ}_{i} - {τ}_{c}} + ln ( \frac{Pr [ {τ}_{i} ]}{Pr [ {τ}_{c} ]} ) ] \\ = Pr [ {W}_{i} > {T}_{i} ]\end{matrix}$$

where

$${W}_{i} = {\sum }_{l = 0}^{C - 1} {a}_{l} ( n ( {τ}_{c} + l ) - n ( {τ}_{i} + l )$$

is gaussian distributed with zero mean, and standard deviation equal to

$${σ}_{W} = \sqrt{2 {\sum }_{l = 0}^{C - 1} {a}_{l}^{2}}$$

and the threshold Tᵢ is given by:

$${T}_{i} = - {\sum }_{l = 0}^{C - 1} {a}_{l}^{2} + {\sum }_{l = 0}^{C - 1} {a}_{l} {a}_{l + {τ}_{i} - {τ}_{c}} + ln ( \frac{Pr [ {τ}_{i} ]}{Pr [ {τ}_{c} ]} )$$

The first summation is the total energy of the correlation peak. The larger this energy term, the larger the value of p_{c,i} and hence the smaller the probability of a payload error in Equation 6. The second summation is the auto-correlation of the peak shape for non-zero shifts. The larger this term, i.e. the more smeared the correlation peak is, the larger the probability of error.

The expression for p_{c,i} can now be written as:

$$\begin{matrix}{p}_{c , i} = Pr [ {W}_{i} > {T}_{i} ] \\ = 1 - Φ [ \frac{{T}_{i}}{{σ}_{W}} ]\end{matrix}$$

where Φ(Z) is the cumulative probability distribution of a zero mean, unit standard deviation gaussian random variable. Finally, substituting this into the expression for the probability of error (Equation 6) gives:

$$Pr [ Error ] = 1 - {\prod }_{{i = 0}_{i \neq c}}^{N - 1} ( 1 - Φ [ \frac{{T}_{i}}{{σ}_{W}} ] ) \qquad ( 8 )$$

This probability of making an error in determining the payload shift gives a measure of the reliability of the extracted watermark payload.

1. A method of processing an information signal in which a plurality of watermarks (Wi) are present, the plurality of watermarks together defining a payload, the method comprising:
detecting the presence (60-62) of each of the plurality of watermarks (Wi) in the information signal;
determining the payload (70, 75) represented by the watermarks; and,
calculating a measure of confidence (110) in the accuracy of the payload represented by the watermarks.

2. A method according to claim 1 further comprising comparing (112) the measure of confidence with a threshold confidence value (111) and providing an output (113) based on the comparison with the threshold confidence value.

3. A method according to claim 2 further comprising not determining the payload represented by the plurality of watermarks if the output (113) indicates that the measure of confidence is below the threshold confidence value.

4. A method according to claim 1 wherein the step of detecting the presence (60-62) of each watermark comprises:
deriving, for each watermark, a set of correlation results (64) by correlating the information signal with one of the watermarks (Wi) for each of a plurality of relative positions of the information signal with respect to the watermark; and
detecting a correlation peak (65, 85) in the set of correlation results (64) for each watermark.

5. A method according to claim 4 wherein the measure of confidence in the payload is based on the correlation results in the region of the correlation peak.

6. A method according to claim 5 wherein the measure of confidence is related to the total energy of the correlation peak.

7. A method according to claim 5 wherein the measure of confidence is related to the shape of the correlation peak.

8. A method according to claim 4 further comprising identifying clusters of correlation results (65) which are likely to represent correlation peaks and processing the clusters to identify the cluster that is most likely to represent the true correlation peak.

9. A method according to claim 8 wherein the step of identifying clusters of correlation results (65) comprises determining all correlation results in the set which exceed the threshold value and then determining which of those correlation results are located within a predetermined distance of each other.

10. A method according to claim 4 wherein the step of detecting the presence of watermarks comprises comparing at least part of the set of correlation results with information about an expected shape of a correlation peak in the results.

11. (canceled)

12. An arrangement for processing an information signal in which a plurality of watermarks (Wi) are present, the plurality of watermarks together defining a payload, the arrangement comprising:
means for detecting (60-62) the presence of each of the plurality of watermarks (Wi) in the information signal;
means for determining (70, 75) the payload represented by the watermarks; and,
means for calculating (110) a measure of confidence in the accuracy of the payload represented by the watermarks.

13. (canceled)

14. An arrangement according to claim 12 wherein the means for detecting, means for determining and means for calculating comprise a processor which is arranged to execute software for performing those functions.

15. Apparatus for presenting an information signal comprising means for disabling operation of the apparatus in dependence on the presence of a valid watermark in the information signal, wherein the apparatus comprises an arrangement according to claim 12.

16. An arrangement for processing an information signal in which a plurality of watermarks (Wi) are present, the plurality of watermarks together defining a payload, the arrangement comprising:
a processor for detecting the presence of each of the plurality of watermarks in the information signal; said processor determining the payload represented by the watermarks and calculating a measure of confidence in the accuracy of the payload represented by the watermarks.
